(19) United States
(12) Patent Application Publication
(10) Pub. No.: US 2026/0003482 A1
(43) Pub. Date: Jan. 1, 2026

(54) INTERACTION METHOD, ELECTRONIC DEVICE, AND STORAGE MEDIUM

(71) Applicant: Lenovo (Beijing) Limited, Beijing (CN)

(72) Inventors: Ankang FENG, Beijing (CN); Hanliu CHEN, Beijing (CN)

(21) Appl. No.: 19/251,766

(22) Filed: Jun. 26, 2025

(30) Foreign Application Priority Data
Jun. 29, 2024 (CN) 202410870512.7

(51) Int. Cl. G06F 3/0484; G06F 3/14

(52) U.S. Cl. CPC G06F 3/0484; G06F 3/1454

(57) ABSTRACT

An interaction method and an interaction device for a display interface are provided. The display interface includes at least one object interaction area and a shared display area. The method includes receiving an operation instruction for an interaction object through an object interaction area of the at least one object interaction area; and in response to the operation instruction, displaying content to be operated of the interaction object in the shared display area. The object interaction area and the shared display area are in different areas of the display interface.

### CROSS-REFERENCES TO RELATED APPLICATIONS

The present disclosure claims priority of Chinese Patent Application No. 202410870512.7, filed on Jun. 29, 2024, the entire content of which is hereby incorporated by reference.

### FIELD OF THE DISCLOSURE

The present disclosure generally relates to the field of computer technology and, more particularly, relates to an interaction method for a display interface and an interaction device for a display interface.

### BACKGROUND

In existing technology, most applications on computers or mobile devices may include online preview and editing functions for documents. To polish a specific paragraph or generate a chart from data, it may be necessary to exit a current desktop application, search for materials on the Internet, and copy and paste the materials, or use an original document tool to generate a chart. Exiting a current desktop application may result in a long interactive link, a poor user experience, and low operation efficiency, and learning costs may thus be increased.

### SUMMARY

One aspect of the present disclosure includes an interaction method for a display interface. The display interface includes at least one object interaction area and a shared display area. The method includes receiving an operation instruction for an interaction object through an object interaction area of the at least one object interaction area; and in response to the operation instruction, displaying content to be operated of the interaction object in the shared display area. The object interaction area and the shared display area are in different areas of the display interface.

Another aspect of the present disclosure includes an electronic device. The electronic device includes one or more processors and a memory containing a computer program that, when being executed, causes the one or more processors to perform an interaction method for a display interface that includes at least one object interaction area and a shared display area. The one or more processors are configured to perform: receiving an operation instruction for an interaction object through an object interaction area of the at least one object interaction area; and in response to the operation instruction, displaying content to be operated of the interaction object in the shared display area. The object interaction area and the shared display area are in different areas of the display interface.

Another aspect of the present disclosure includes a non-transitory computer readable storage medium containing a computer program that, when being executed, causes at least one processor to perform an interaction method for a display interface that includes at least one object interaction area and a shared display area. The at least one processor is configured to perform: receiving an operation instruction for an interaction object through an object interaction area of the at least one object interaction area; and in response to the operation instruction, displaying content to be operated of the interaction object in the shared display area. The object interaction area and the shared display area are in different areas of the display interface.

Other aspects of the present disclosure may be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates an implementation flow chart of an interaction method for a display interface consistent with the disclosed embodiments of the present disclosure;

FIG. 2A illustrates another implementation flow chart of an interaction method for a display interface consistent with the disclosed embodiments of the present disclosure;

FIG. 2B illustrates a schematic display diagram of a shared display area consistent with the disclosed embodiments of the present disclosure;

FIG. 2C illustrates another schematic display diagram of a shared display area consistent with the disclosed embodiments of the present disclosure;

FIG. 3A illustrates another implementation flow chart of an interaction method for a display interface, consistent with the disclosed embodiments of the present disclosure;

FIG. 3B illustrates a schematic diagram of generating target content in an agent interaction area, consistent with the disclosed embodiments of the present disclosure;

FIG. 4 illustrates another implementation flow chart of an interaction method for a display interface, consistent with the disclosed embodiments of the present disclosure;

FIG. 5 illustrates another implementation flow chart of an interaction method for a display interface, consistent with the disclosed embodiments of the present disclosure;

FIG. 6 illustrates another implementation flow chart of an interaction method for a display interface, consistent with the disclosed embodiments of the present disclosure;

FIG. 7 illustrates another implementation flow chart of an interaction method for a display interface, consistent with the disclosed embodiments of the present disclosure;

FIG. 8 illustrates a schematic diagram of a display interface consistent with the disclosed embodiments of the present disclosure;

FIG. 9 illustrates another implementation flow chart of an interaction method for a display interface, consistent with the disclosed embodiments of the present disclosure;

FIG. 10 illustrates a schematic diagram of a composition structure of an interaction device of a display interface, consistent with the disclosed embodiments of the present disclosure; and

FIG. 11 illustrates a schematic diagram of a hardware entity of an electronic device consistent with the disclosed embodiments of the present disclosure.

### DETAILED DESCRIPTION

To make the objectives, technical solutions and advantages of the present disclosure more clear and explicit, the present disclosure is described in further detail with accompanying drawings and embodiments. It should be understood that the specific exemplary embodiments described herein are only for explaining the present disclosure and are not intended to limit the present disclosure.

It should be noted that in the present disclosure, relational terms such as “first” and “second” are only configured to distinguish one entity or operation from another entity or operation, and do not necessarily require or imply that such actual relationship or sequence exists between these entities or operations. Terms “comprise”, “include” or any other variations thereof are intended to cover a non-exclusive inclusion. A process, method, article, or apparatus that includes a series of elements includes not only the series of elements, but also other elements not expressly listed, or elements inherent to such a process, method, article, or apparatus. Without further limitation, an element defined by a statement like “comprises a . . . ” does not exclude the presence of additional identical elements in a process, method, article, or apparatus that includes the foregoing element.

It should be noted that relative arrangements of components and operations, numerical expressions and numerical values set forth in exemplary embodiments are for illustration purposes only and are not intended to limit the present disclosure unless otherwise specified. Techniques, methods and apparatus known to the skilled in the relevant art may not be discussed in detail, but these techniques, methods and apparatus should be considered as a part of the specification, where appropriate.

In existing technology, most applications on computers or mobile devices may include online preview and editing functions for documents. To polish a specific paragraph or generate a chart from data, it may be necessary to exit a current desktop application, search for materials on the Internet, and copy and paste the materials, or use an original document tool to generate a chart. Exiting a current desktop application may result in a long interactive link, a poor user experience, and low operation efficiency, and learning costs may thus be increased.

The present disclosure provides an interaction method for a display interface. In one embodiment, the display interface includes at least one object interaction area and a shared display area. The at least one object interaction area may use artificial-intelligence natural language processing and machine learning capabilities to directly complete document polishing, icon generation and other operations within an application. As such, the document operations may not require exiting the current application, and the document operations may thus become simpler and more efficient. Accordingly, the convenience and smoothness of the interaction experience may be improved.

The interaction method may be executed by one or more processors of an electronic device. The electronic device may refer to a device with data processing capabilities, such as a server, a laptop, a tablet computer, a desktop computer, a smart TV, a set-top box, and a mobile device. The mobile device may be a mobile phone, a portable video player, a personal digital assistant, a dedicated messaging device, or a portable gaming device.

FIG. 1 illustrates an implementation flow chart of an interaction method for a display interface consistent with the disclosed embodiments of the present disclosure. The interaction method may be executed by one or more processors of an electronic device. The display interface includes at least one object interaction area and a shared display area. In one embodiment, as shown in FIG. 1, the method includes S101 and S102.

S101: receiving an operation instruction for an interaction object through an object interaction area. In some embodiments, the display interface is configured to display at least one object interaction area and a shared display area. The display interface may be a screen interface of an electronic device. For example, the display interface may be a screen interface of a laptop computer.

In some embodiments, the display interface includes at least one object interaction area. Each of the at least one object interaction area is located in a different area of the display interface. For example, the at least one object interaction area may include two object interaction areas: a first object interaction area, and a second object interaction area. The first object interaction area is located in the left area of the display interface, and the second object interaction area is located in the right area of the display interface. The present disclosure does not specifically limit the location of each object interaction area on the display interface.

In some embodiments, the display interface also includes a shared display area. The shared display area may be located anywhere on the display interface. It may be understood that the shared display interface and each of the at least one object interaction area may have different positions on the display interface.

In some embodiments, the operation instruction may be an instruction sent by a user based on an input device such as a mouse or keyboard, or may be an instruction sent through a touch screen or voice. It may be understood that the operation instruction may be an opening instruction, a closing instruction, or a selection instruction, for any function in the object interaction area.

In some embodiments, the interaction object refers to an object in the object interaction area that may be used to select a function, a file, a window, and the like, which are presented in the interaction area.

In some embodiments, the operation instruction for an interaction object may be received through the object interaction area. It may be understood that, by setting at least one object interaction area at different positions of the display interface, operation instructions such as opening, closing, selecting, and the like, sent by a user through a mouse, a keyboard, a touch screen, a voice, and the like, for a function, a file, a window, and the like, in the object interaction area, may be received.

For example, through the first object interaction area disposed on the left side of the display interface, an opening instruction of a user clicking a target function among a plurality of functions in the first object interaction area through a mouse may be received. Alternatively, through the second object interaction area disposed on the right side of the display interface, an editing instruction input by a user for a target file among a plurality of files in the second object interaction area may be received.

S102: in response to the operation instruction, displaying content to be operated of the interaction object in the shared display area. In some embodiments, the shared display area is configured to, based on the object interaction area, receive operation instructions from the user for functions, files, and the like, in the object interaction area through a mouse, a keyboard, a touch screen, a voice, and the like, and display the content to be operated in the functions, files, and the like, in the object interaction area in the shared display area.

In some embodiments, based on the operation instruction such as approach, adsorption, alignment, and the like, with the object interaction area in the display interface, the shared display area may display the content to be operated in the functions, files, and the like, in the object interaction area, in the shared display area. For example, the mouse may be used to stick to the object interaction area and drag the object interaction area to adjust the position of the object interaction area in the display interface. When the border of the interaction area approaches the boundary of the shared display area and the spacing between the border of the interaction area and the boundary of the shared display area is less than a certain threshold, the border of the interaction area and the boundary of the shared display area may be automatically adsorbed and spliced into a whole. In this case, the operation instructions of the functions, files, and the like, in the object interaction area may be merged into the shared display area. That is, the content to be operated in the functions, files, and the like, in the object interaction area may be displayed in the shared display area.

In some embodiments, the content to be operated of the interaction object represents the functions, files, windows, and the like, in the interaction object, which need to be operated. For example, when the interaction object includes a plurality of functions, such as a document editing function, a shopping function, a chat function, and the like, the content to be operated may include at least one of the following: a document editing function, a shopping function, a chat function, and the like. When the interaction object includes a plurality of files, the content to be operated may include at least one of the following: a table file, a text file, and the like.

In some embodiments, in response to the operation instruction, the content to be operated of the interaction object may be displayed in the shared display area. It may be understood that in the display interface, instructions such as opening, closing, and selecting instructions, sent by a user through a mouse, keyboard, touch screen, voice, and the like, for document editing functions, shopping functions, chat functions, and the like, or table files, text files, and the like, may be received through any object interaction area of the at least one object interaction area; and the shared display interface may display any one of the functions, documents, windows, and the like, or the table files, the text files, and the like, in the object interaction area.

For example, in the display interface, through the first object interaction area of the at least one object interaction area, an opening instruction for a target window in the first object interaction area sent by a user through a mouse may be received, and the target window may be displayed in the shared display interface. Alternatively, a preview instruction, sent by a user through a keyboard, for a target document in the second object interaction area in the at least one object interaction area may be received, and the target document may be displayed in the shared display area.

In some other embodiments, the display interface includes two object interaction areas: a first object interaction area, and a second object interaction area. In response to a first operation instruction sent by a user through a mouse on a target function in the first object interaction area received through the first object interaction area, the target function may be displayed in the shared display area. At this time, in response to a second operation instruction sent by the user through the keyboard for the target document in the second interaction area received through the second object interaction area, when the target function is displayed in the shared display area, the display content of the target function in the current shared display area may be cancelled, and the display content of the target document may be added to the shared display area. It may be understood that, the display content of the target document is not closed. In response to the first operation instruction from a user for the target function in the first object interaction area received again through the first object interaction area, the target content of the target function displayed last time may added to the shared display area, and the display content of the target document currently displayed in the shared display area may be cancelled.

In some embodiments, the at least one object interaction area and the shared display area are arranged in different areas of the display interface. The at least one object interaction area and the shared display area may correspond to different applications respectively. It may be understood that the at least one object interaction area and the shared display area may be located at different positions of the display interface. Each object interaction area of the at least one object interaction area and the shared display area includes independent applications. The at least one object interaction area and the shared display area may implement data transmission by calling each other's application interface. For example, an object interaction area may locally store the data of the object interaction area. The shared display area may access the data of the object interaction area by calling the application program interface of the object interaction area. As such, the data of the object interaction area may be displayed in the shared display area.

In one embodiment, different operation instructions of the user for the interaction objects in each object interaction area may be received through each object interaction area of the at least one object interaction area of the display interface, and the content to be operated of the interaction object may be displayed in the shared display area of the display interface. As such, the problem of having to exit the current interface for operating different functions and data may be avoided, the operation and learning efficiencies may be improved, and user experience may be improved.

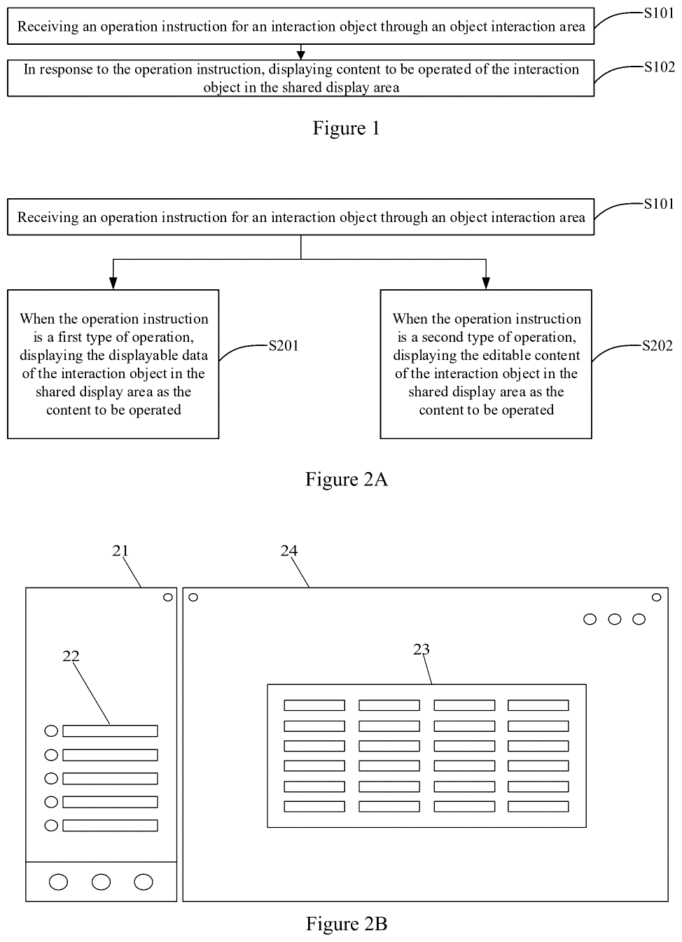

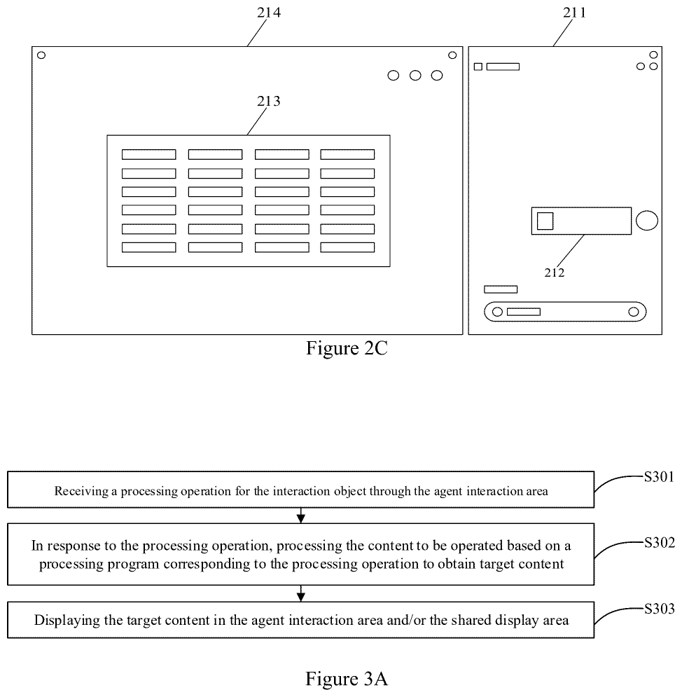

FIG. 2A illustrates another implementation flow chart of an interaction method for a display interface consistent with the disclosed embodiments of the present disclosure. The interaction method may be executed by a processor of an electronic device. Referring to FIGS. 1 and 2A, an operation of S102 in FIG. 1 may be updated to S201 or S202 in FIG. 2A.

S201: when the operation instruction is a first type of operation, displaying the displayable data of the interaction object in the shared display area as the content to be operated.

In some embodiments, the operation instruction received by the at least one object interaction area may be parsed. The operation instruction may include a first type of operation. The first type of operation may be a selection operation, an opening operation, a preview operation, and the like, for a function, a window, a file, and the like, of an interaction object in the object interaction area. For example, when the interaction object is a function, such as a chat function, a shopping function, and the like, the first type of operation may be an opening operation for opening the chat function, or a selection operation for selecting the shopping function. When the interactive function is a file, the first type of operation may be to preview the file

In some embodiments, the content to be operated may be displayable data of the interaction object. For example, when the interaction object in the object interaction area is a chat function, a shopping function, and the like, the content to be operated may be a chat box of the chat object or a mall of the shopping function, and the like. When the interaction object in the object interaction area is a file, the content to be operated may be a text document, a spreadsheet document, a presentation document, and the like.

In some embodiments, when the operation instruction is a first type of operation, the displayable data of the interaction object may be displayed in the shared display area as the content to be operated. FIG. 2B illustrates a schematic display diagram of a shared display area consistent with the disclosed embodiments of the present disclosure. Referring to FIG. 2B, when the operation instruction is a selection operation, an opening operation, a preview operation, and the like, for a function, a window, a file, and the like, of an interaction object 22 in the object interaction area 21, the content to be operated 23 may be a chat box of a chat object or a mall of a shopping function, and the like, or a text document, a spreadsheet document, a presentation document, and the like of a file. The displayable data, the chat box of the chat object or the mall of the shopping function in the interactive object 22 in the object interaction area 21, or the text document, spreadsheet document, presentation document, and the like, in the file of may be displayed in the shared display area 24.

S202: when the operation instruction is a second type of operation, displaying the editable content of the interaction object in the shared display area as the content to be operated.

In some embodiments, the operation instruction received by the at least one object interaction area may be parsed. The operation instruction may include a second type of operation. The second type of operation may be an editing operation on files and data of the interaction object in the object interaction area, such as a table generation operation, a text polishing operation, a data calculation operation, and the like. For example, when the interaction object in the object interaction area is a document, the second type of operation may be a table generation operation or a text polishing operation. When the interaction object in the object interaction area is data, the second type of operation may be a data calculation operation.

In some embodiments, the content to be operated may be editable data in the interaction object. For example, when the second type of operation is a table generation operation or a text polishing operation, the content to be operated may be numbers or text in the document. When the second type of operation is a data calculation operation, the content to be operated may be characters or formulas in the data.

In some embodiments, when the operation instruction is a second type of operation, the editable content of the interaction object may be displayed in the shared display area as the content to be operated. FIG. 2C illustrates another schematic display diagram of a shared display area consistent with the disclosed embodiments of the present disclosure. Referring to FIG. 2C, when the operation type is an editing operation on the file or data of the interaction object 212 in the object interaction area 211, such as a table generation operation, a text polishing operation, a data calculation operation, and the like, the content to be operated 213 may be a number or text in the file, or a character or formula in the data. The number, text, character or formula in the editable data file of the interaction object 212 in the object interaction area 211 may be displayed in the shared display area 214.

In one embodiment, by parsing the operation instruction, the corresponding first type of operation and the second type of operation may be obtained. The content to be operated of the interaction object in the at least one object interaction area may be displayed through the shared display area. As such, when operating the content to be operated, there is no need to exit the current interface. Accordingly, the processing efficiency may be improved, and the user experience may be improved.

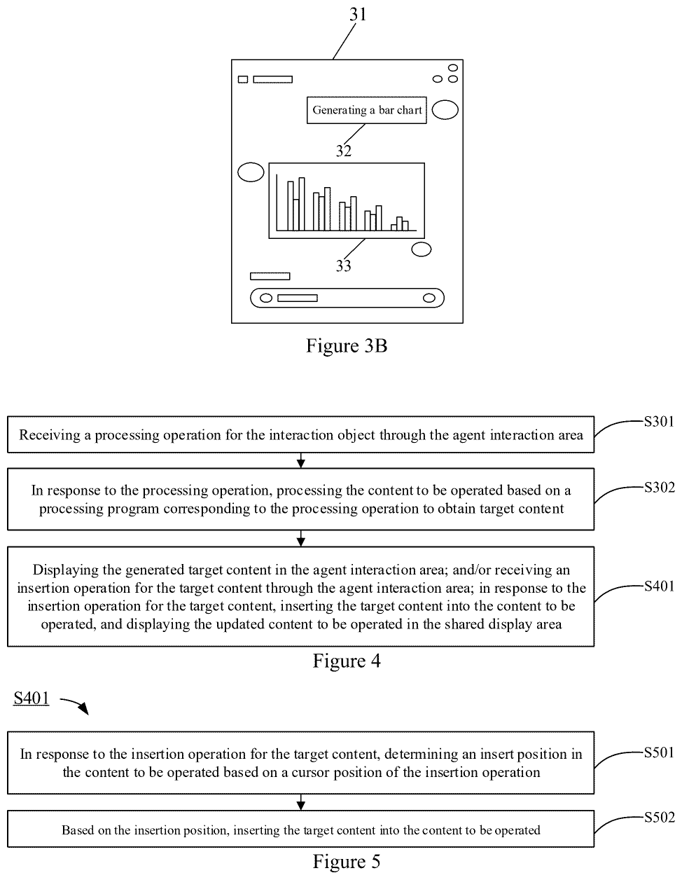

FIG. 3A illustrates another implementation flow chart of an interaction method for a display interface, consistent with the disclosed embodiments of the present disclosure. The interaction method may be executed by a processor of an electronic device. Referring to FIG. 3A, the at least one object interaction area may include an agent interaction area, and the interaction method may include operations S301 to S303.

S301: receiving a processing operation for the interaction object through the agent interaction area. In some embodiments, the agent interaction area is configured to analyze the content to be operated of the interaction object based on the processing operation to obtain the target content. For example, the agent interaction area may process the content to be operated in the interaction object according to a polishing operation to obtain the polished content.

In some embodiments, the processing operation for the interaction object may be received through the agent interaction area. It may be understood that the editable content of the interaction object in the agent interaction area may be taken as the content to be operated. The processing operation for the content to be operated of the editable content may be received through the agent interaction area. For example, when the content to be operated is table data, the processing operation for the table data may be received through the agent interaction area. When the content to be operated is text, the processing operation for the text may be received through the agent interaction area.

S302: in response to the processing operation, processing the content to be operated based on a processing program corresponding to the processing operation to obtain target content. In some embodiments, the processing operation includes at least one of the following: a graphics generation operation, a text polishing operation, a presentation content generation operation, and the like. In some embodiments, the processing program corresponding to the processing operation may be a processing program corresponding to generating graphics, a processing program for generating presentation content, a processing program for polishing text, and the like.

In some embodiments, in response to the processing operation, the content to be operated may be processed based on a processing program corresponding to the processing operation to obtain target content. It may be understood that the processing operation of the operation to be edited on the editable content in the interaction object may be received through the agent interaction area. The agent interaction area may process the operation to be edited of the editable content according to the type of processing program corresponding to the type of processing operation to obtain the target content.

FIG. 3B illustrates a schematic diagram of generating target content in an agent interaction area, consistent with the disclosed embodiments of the present disclosure. In one embodiment, referring to FIG. 3B, the agent interaction area 31 may receive a bar chart generation operation 32 for the table data in the interaction object. The agent interaction area 31 may analyze and process the table data according to a bar chart generation program corresponding to the bar chart generation operation 32 to obtain a bar chart 33.

S303: displaying the target content in the agent interaction area and/or the shared display area. In some embodiments, after the agent interaction area processes the operation to be edited of the editable content according to the processing program type corresponding to the processing operation type to obtain the target content, the target content may be displayed in the agent interaction area, and/or the target content may be displayed in the shared display area.

For example, the agent interaction area may receive a text polishing operation for text data in the interaction object. The agent interaction area may analyze and process the text data according to a text polishing program corresponding to the text polishing operation to obtain polished text data. The polished text data may be displayed in the agent interaction area, and/or the polished text data may be displayed in the shared display area.

In one embodiment, the agent interaction area may receive a processing operation for editable content, and the editable content may be processed through a processing program corresponding to the processing operation for the editable content, to obtain the target content. The target content may be displayed in the agent interaction area and/or the shared display area. As such, exiting the current interface may be avoided, operation efficiency may be improved, and user experience may be improved. In addition, there is no need to expand the current area to adaptively configure the preview or display area when the limited current area is not enough to enlarge the content or display the content in full screen. For example, manually adjusting the border area of a current interface may not be needed. As such, user operation may be convenient.

FIG. 4 illustrates another implementation flow chart of an interaction method for a display interface, consistent with the disclosed embodiments of the present disclosure. The interaction method may be executed by a processor of an electronic device. Referring to FIGS. 3A and 4, an operation of S303 in FIG. 3A may be updated to S401.

S401: displaying the generated target content in the agent interaction area; and/or receiving an insertion operation for the target content through the agent interaction area; in response to the insertion operation for the target content, inserting the target content into the content to be operated, and displaying the updated content to be operated in the shared display area.

In some embodiments, the generated target content may be displayed in the agent interaction area. It may be understood that, after the agent interaction area processes the content to be edited of the editable content according to the processing program type corresponding to the processing operation type to obtain the target content, the target content may be displayed in the agent interaction area.

For example, a text polishing operation for text data in the interaction object may be received through the agent interaction area. The agent interaction area may analyze and process the text data according to a text polishing program corresponding to the text polishing operation to obtain polished text data. The polished text data may be displayed in the agent interaction area.

In some embodiments, displaying the updated content to be operated in the shared display area may be achieved in the following approach. The agent interaction area may receive an insertion operation for the target content. In response to the insertion operation for the target content, the agent interaction area may insert the target content into the content to be operated. It may be understood that the insertion operation input by the user for the target content may be received through the agent interaction area. The agent interaction area may insert the target content obtained by processing the content to be edited of the editable content according to the insertion operation through the agent interaction area according to the processing program type corresponding to the processing operation type, into the content to be operated in the shared display area, and the content to be operated may thereby be updated. As such, the updated content to be operated may be displayed in the shared display area, that is, the target content may be displayed in the shared display area.

As an example, in one embodiment, the content to be operated is text data, and the target content is polished text. The insertion operation for inputting the polished text, input by means of a mouse, keyboard, touch screen, voice, and the like, may be received through the agent interaction area. According to the inserting operation, the agent interaction area may insert the polished text obtained by the agent interaction area processing the text data according to the text polishing program of the text polishing operation, into the text data position in the shared display area, to update the text data with the polished text. As such, the shared display area may display the updated text data. That is, the polished text may be displayed in the shared display area.

In one embodiment, the insertion operation for the target content may be received through the agent interaction area. The agent interaction area may insert the target content into the position of the content to be operated in the shared display area. As such, the goal of the shared display area and the agent interaction area displaying the target content may be realized, and the user experience may be improved.

FIG. 5 illustrates another implementation flow chart of an interaction method for a display interface, consistent with the disclosed embodiments of the present disclosure. Referring to FIGS. 4 and 5, an operation of “in response to the insertion operation for the target content, inserting the target content into the content to be operated” in S401 may be updated as S501 and S502.

S501: in response to the insertion operation for the target content, determining an insert position in the content to be operated based on a cursor position of the insertion operation.

In some embodiments, the method may be implemented in the following approach. In response to the insertion operation for the target content, the current cursor position may be received through the shared display area, and based on the cursor position of the insertion operation, the insertion position in the content to be operated may be determined. It may be understood that, when the insertion operation for the target content is received through the agent interaction area, the cursor position after the user operates the cursor in the shared display area may be received through the shared display area. The agent interaction area may determine the insertion position for inserting the target content into the content to be operated, based on the cursor position of the insertion operation.

As an example, the content to be operated is taken as table data, and the target content is taken as a bar chart. When the insertion operation for the bar chart is received through the agent interaction area, a cursor position in the shared display area after a user moves a cursor by means of a mouse, keyboard, touch screen control, voice control, or the like, may be received through the agent interaction area. The agent interaction area may determine an insertion position for inserting the bar chart into the table data in the shared display area according to the cursor position after the cursor is moved. That is, the cursor position after the cursor is moved may be determined as the insertion position of the bar graph into the table data in the shared display area.

S502: based on the insertion position, inserting the target content into the content to be operated. In some embodiments, the target content may be inserted into the content to be operated based on the insertion position. It may be understood that, according to the cursor position received by the shared display area after the user operates the cursor in the shared display area, the target content may be inserted into the content to be operated in the shared display area. As such, the target content may be displayed in the shared display area.

For example, a cursor position after a user moves a cursor in the shared display area by using a mouse, keyboard, touch screen control, voice control, and the like, may be received through the shared display area. According to the cursor position after the cursor is moved, the bar chart may be inserted into the table data in the shared display area, such that the updated table data may be displayed in the shared display area, that is, the bar chart may be displayed in the shared display area.

In one embodiment, the cursor position in the shared display area after the user operates the cursor may be received through the shared display area. The cursor position after the cursor is operated may be determined as the insertion position of the target content. The target content may be inserted into the content to be operated in the shared display area based on the insertion position of the target content. As such, the target content may be displayed in the shared display area. Accordingly, the problem of having to exit the current interface to insert target content may be avoided, the operation and learning efficiency may be improved, and the user experience may be improved.

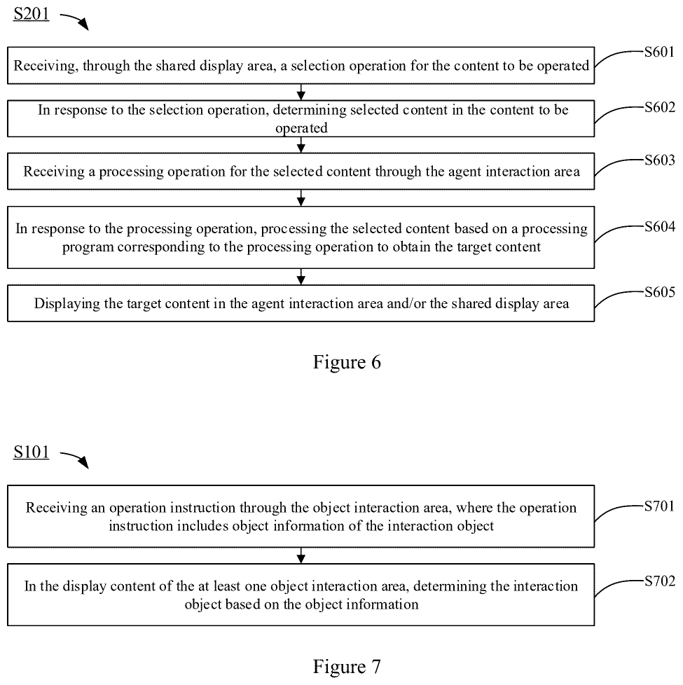

FIG. 6 illustrates another implementation flow chart of an interaction method for a display interface, consistent with the disclosed embodiments of the present disclosure. The method may be executed by a processor of an electronic device. Referring to FIGS. 2A and 6, an operation of S201 in FIG. 2A may be updated to operations S601 to S605.

S601: receiving, through the shared display area, a selection operation for the content to be operated. In some embodiments, the selection operation may include at least one of the following: frame selection operation through mouse, movement selection operation through keyboard, manual selection operation through touch screen, voice selection operation through voice, and the like.

In some embodiments, the content to be operated may be editable content in the interaction object. For example, the content to be operated may be text data, table data, presentation data, and the like.

In some embodiments, the selection operation on the content to be operated may be received through the shared display area. It may be understood that, through the shared display area, the selection operation performed by the user on the editable content in the interaction object through at least one operation in the shared display area may be received.

For example, through the shared display area, the user's movement selection operation on text data, table data, presentation data, and the like, in the shared display area through a keyboard may be received. Alternatively, the user's movement selection operation on text data, table data, presentation data, and the like, in the shared display area by using a mouse may be received. Alternatively, the user's manual selection operation controlling text data, table data, presentation data, and the like, in the shared display area through a touch screen may be received. Alternatively, a user's voice selection operation for text data, table data, presentation data, and the like, in the shared display area through voice may be received.

S602: in response to the selection operation, determining selected content in the content to be operated. In some embodiments, in response to the selection operation, the selected content may be determined in the content to be operated. It may be understood that, according to the selection operation input by the user in at least one approach with respect to the editable content in the interaction object received through the shared display area, the selected editable content may be determined from the editable content of the interaction object in the shared display area.

For example, the user's frame selection operation through a mouse, movement selection operation a keyboard, manual selection operation a touch screen, a voice selection operation through voice, and the like, for text data, table data, presentation data, and the like, may be received through the shared display area. The selected editable content may be determined from the text data, table data, presentation data, and the like, in the interaction object in the shared display area. The selected editable content may include at least one of text data, table data, presentation data, and the like.

S603: receiving a processing operation for the selected content through the agent interaction area. In some embodiments, the selected content represents the editable content in the interaction object. The selected content may include text data, table data, presentation data, and the like. In some embodiments, the processing operation may include at least one of the following: polishing text, generating a bar chart, generating a presentation, and the like.

In some embodiments, the processing operation for the selected content may be received through the agent interaction area. It may be understood that, the user's processing operation on the editable content in the interaction object in at least one approach may be received through the agent interaction area receives.

For example, the processing operation of text polishing, bar chart generation, presentation generation, and the like, for text data, table data, and presentation data in the interaction object, input by the user through mouse, keyboard, touch screen, voice, and the like, may be received by the agent interaction area.

S604: in response to the processing operation, processing the selected content based on a processing program corresponding to the processing operation to obtain the target content.

In some embodiments, when the selected content is text data, table data, or presentation data, the processing operation may be a text polishing operation, a bar chart generation operation, or a presentation generation operation. The processing program may be a text polishing program, a bar chart generation program, a presentation generation program, and the like. In some embodiments, the target content may be polished text, a bar chart, a presentation, or the like.

In some embodiments, in response to the processing operation, the selected content may be processed based on the processing program corresponding to the processing operation to obtain the target content. It may be understood that, the processing operation input by the user in at least one approach for the selected content of the interaction object may be received through the agent interaction area. The selected content of the interaction object may be processed based on a processing program corresponding to the processing operation to generate the target content.

For example, a text polishing operation, a bar graph generation operation, and a presentation generation operation input by a user through a mouse, keyboard, touch screen, or voice for the text data, table data, and presentation data of the interaction object may be received through the agent interaction area. The text data, table data, and presentation data may be processed through a text polishing program, a bar graph generation program, and a presentation generation program corresponding to the text polishing operation, the bar graph generation operation, and the presentation generation operation. As a result, a polished text, a bar graph, a presentation, and the like, may be generated.

S605: displaying the target content in the agent interaction area and/or the shared display area. In some embodiments, the target content may include at least one of the following: generating polished text, a bar chart, a presentation, and the like.

In some embodiments, the user's insertion operation may be received through the agent interaction area. The generated polished text, bar chart, and presentation may be inserted into the content position selected in the shared display area. The generated polished text, bar chart, presentation, and the like, may be displayed in the shared display area.

In one embodiment, the selection operation input by the user for the content to be operated may be received by the agent interaction area, and the selected content may be determined based on the selection operation. Then, the user's processing operation on the selected content may be received through the agent interaction area, and target content may be generated based on the processing operation. The target content may be displayed in the agent interaction area and/or the shared display area. As such, the problem of having to exit the current interface when processing the data to be processed may be addressed, operation and learning efficiency may be improved, and user experience may be improved.

FIG. 7 illustrates another implementation flow chart of an interaction method for a display interface, consistent with the disclosed embodiments of the present disclosure. The interaction method may be executed by a processor of an electronic device. Referring to FIGS. 1 and 7, an operation of S101 in FIG. 1 may be updated to S701 and step S702 in FIG. 7.

S701: receiving an operation instruction through the object interaction area, where the operation instruction includes object information of the interaction object. In some embodiments, the operation instruction may be an open instruction, a preview instruction, a selection instruction, a generation instruction, and the like. In some embodiments, the interaction object may be a shopping function, a chat function, text data, an editing function, and the like.

In some embodiments, the operation instruction carries object information of the interaction object. It may be understood that the operation instructions may be instructions for opening a shopping function, instructions for previewing text, instructions for selecting a chat partner, instructions for generating data, and the like.

In some embodiments, the operation instruction may be received through the object interaction area. It may be understood that, through each of the at least one object interaction area, an operation instruction of the user for at least one interaction object may be received. For example, through each of the at least one object interaction area, an instruction to open a shopping function, an instruction to preview text, an instruction to select a chat object, an instruction to generate data, and the like, of a user for the shopping function, chat function, text data, editing function, and the like, may be received.

S702: in the display content of the at least one object interaction area, determining the interaction object based on the object information. In some embodiments, the at least one object interaction area may include a first object interaction area and a second object interaction area. The display content of the first object interaction area may include shopping functions, chat functions, and the like. The display content of the second object interaction area may include text data, generation functions, and the like.

In some embodiments, in the display content of the at least one object interaction area, the interaction object may be determined based on the object information. It may be understood that, in the display content of each object interaction area of the at least one object interaction area, based on the operation instruction including the object information of the interaction object input by the user through each of the object interaction area, the interaction object may be determined from the display content of each of the object interaction area based on the object information.

For example, when the operation instruction is an instruction to select a chat partner, from the shopping function, chat function, text data, editing function, and the like, of each object interaction area, the interaction object may be determined to be the chat function. When the operation instruction is an instruction to open the shopping function, from shopping functions, chat functions, text data, editing functions, and the like, in each object interaction area, the interaction object may be determined to be the shopping function. When the operation instruction is an instruction to preview text, from the shopping function, chat function, text data, editing function, and the like, of each object interaction area, the interaction object may be determined to be the text data.

In one embodiment, the operation instruction including interaction object information may be received through the at least one object interaction area. Based on the object information of the interaction object, the interaction object may be determined from the display content of each object interaction area. As such, when selecting different interaction objects, there is no need to exit the current interface. Accordingly, the user experience may be improved.

In some embodiments, the interaction method may also be implemented in the following real-time approach. The content displayed in the object interaction area may be generated by a first application. The content displayed in the shared interaction area may be generated by a second application corresponding to the content to be operated. The first application may be different from the second application.

In some embodiments, when the object interaction area is an agent interaction area, the first application is an agent program. The content displayed in the agent interaction area may be generated by the agent program, and the functions included in the agent interaction area may also be realized by the agent program. For example, the agent interaction area may generate polished text according to a polishing instruction input by the user for the text to be operated, and the text polishing function may be realized by the agent program.

In some embodiments, the shared display area may display the content to be operated of the interaction object, according to the user's operation on the interaction object in the object interaction area. As such, the second application is an application associated with the interaction object. For example, when the interaction object is text information and the shared display area displays the text information, the second application may be an application for displaying the text information. When the interaction object is a chat function, the second application may be a chat application. As such, the first application in each of the at least one object interaction area may be different from the second application in the shared display area.

In some embodiments, the interaction method may also be implemented in the following real-time approach. The shared display area is configured to, in an initialization state, determine display content based on the target interaction area in the at least one object interaction area. The shared display area is also configured to, in response to the operation instruction, update the display content based on the content to be operated of the interaction object.

In some embodiments, the shared display area is configured to, in an initialization state, determine display content based on the target interaction area in the at least one object interaction area. It is understandable that, in the initialization state of the display interface, each of the at least one object interaction area and the shared display area may not receive any operation instruction input by the user. At this time, there is no content to be displayed in the display area of the shared display area. The shared display area may determine initial display content of the shared display area based on the target interaction area in the at least one object interaction area.

For example, the at least one object interaction area may include a first object interaction area and a second object interaction area. The initialization display content of the shared display area may be determined according to the display content in the interaction area of the first object interaction area and the display content in the second object interaction area. The display content in the interaction area of the first object interaction area may be determined as the initialization display content of the shared display area. Alternatively, the display content in the interaction area of the second object interaction area may be determined as the initialization display content of the shared display area. Alternatively, the display content in the interaction area of the first object interaction area and the display content in the interaction area of the second object interaction area may be determined as the initialization display content of the shared display area.

In some embodiments, the shared display area is also configured to, in response to the operation instruction, update the display content based on the content to be operated of the interaction object. In some embodiments, the operation instruction of the user corresponding to the interaction object may be received through each object interaction area of at least one object interaction area. The shared display area may display the content to be operated in the shared display area according to the operation instruction in the content to be operated of the interactive object, such that the initial display content of the shared display area may be updated.

An exemplary application of the interaction method of the display interface provided by the present disclosure in an actual scenario is described below.

In existing technology, a PC desktop application may include online preview and editing functions of documents. To polish a specific paragraph or generate a chart from data, it may be necessary to exit a current desktop application, search for materials on the Internet, and copy and paste the materials, or use an original document tool to generate a chart. Exiting a current desktop application may result in a long interactive link, a poor user experience, and low operation efficiency, and learning costs may thus be increased.

In response to the above technical problems, the present disclosure adopts a “triple-screen” interaction design. The interaction design may use the natural language processing and machine learning capabilities of the AI agent to directly complete document polishing or chart generation in the application. Since the operations on documents may not require exiting the current application, document operations may be made to be simpler and more efficient, and the convenience and fluency of user interaction may be improved.

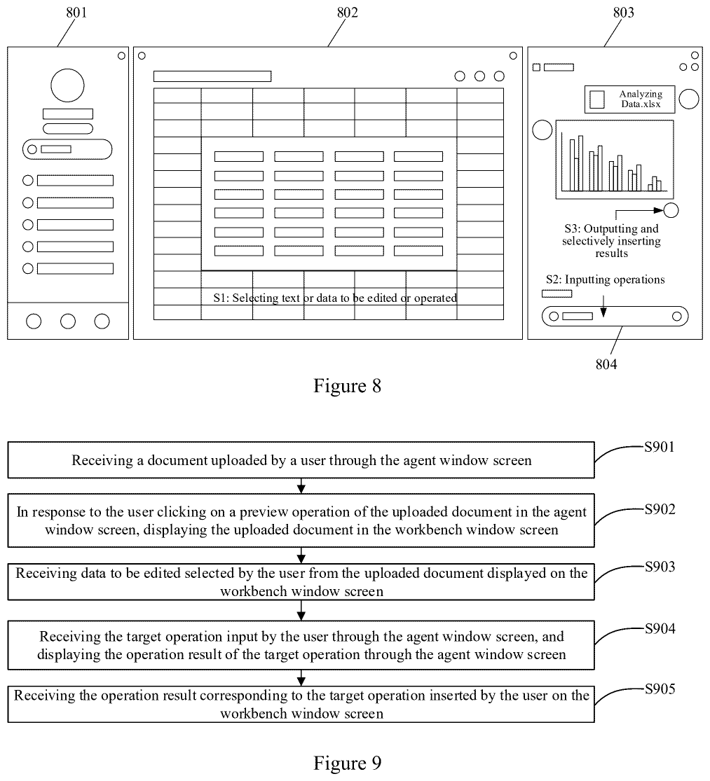

FIG. 8 illustrates a schematic diagram of a display interface consistent with the disclosed embodiments of the present disclosure. In one embodiment, as shown in FIG. 8, the display interface includes a menu window screen 801 (corresponding to the object interaction area in above embodiments), a workbench window screen 802 (corresponding to the shared display area in above embodiments), and an agent window screen 803 (corresponding to the object interaction area in above embodiments). The agent window screen 803 may also include an input area 804. The menu window screen 801 is configured to help a user to find various functions and information. The workbench window screen 802 is configured to display the document uploaded by the user, and the user may edit the uploaded document through the workbench window screen 802. The agent window screen 803 is configured to provide an interface for the user to upload documents. The agent window screen 803 is also configured to output the target result according to the target operation input by the user through the input area 804.

FIG. 9 illustrates another implementation flow chart of an interaction method for a display interface, consistent with the disclosed embodiments of the present disclosure. The interaction method may be executed by a processor of an electronic device. In one embodiment, as shown in FIG. 9, the interaction method includes S901 to S905.

S901: receiving a document uploaded by a user through the agent window screen.

S902: in response to the user clicking on a preview operation of the uploaded document in the agent window screen, displaying the uploaded document in the workbench window screen.

S903: receiving data to be edited selected by the user from the uploaded document displayed on the workbench window screen. In some embodiments, an operation of S903 includes receiving data for which a chart needs to be generated, selected by the user through a mouse from the uploaded document displayed in the workbench window screen 802, or receiving a text paragraph that needs to be polished, selected by the user through a mouse from the uploaded document displayed on the workbench window screen 802.

S904: receiving the target operation input by the user through the agent window screen, and displaying the operation result of the target operation through the agent window screen. In some embodiments, an operation of S904 may include receiving a “generate a bar graph” operation inputted by the user in the input area 804 of the agent window screen 803, and displaying the generated bar graph through the agent window screen 803. Alternatively, the operation of S904 may include receiving a “help with polishing” operation input by the user in the input area 804 of the agent window screen 803, and displaying the generated polished text through the agent window screen 803.

In some embodiments, the method may also include: receiving a “generate a bar graph” operation or a “help with polishing” operation selected by the user in the workbench window screen 802, and displaying the generated bar chart or the generated polished text through the agent window screen 803.

S905: receiving the operation result corresponding to the target operation inserted by the user on the workbench window screen. In some embodiments, an operation of S905 may include receiving the generated bar chart inserted by the user on the workbench window screen 802, or receiving the polished text inserted by the user on the workbench window screen 802.

In one embodiment, by adopting the triple-screen interaction design and utilizing the natural language processing and machine learning capabilities of the AI agent, document polishing or chart generation may be completed directly within the application. Accordingly, the convenience and fluency of user interaction may be improved.

The present disclosure also provides a device. Units included in the devices, and modules included in each of the units, may be implemented by a processor in an electronic device. The units and the modules may also be realized through specific logic circuits. During implementation, the processor may be a central processing unit (CPU), a microprocessor (MPU), a digital signal processor (DSP), or a field programmable gate array (FPGA).

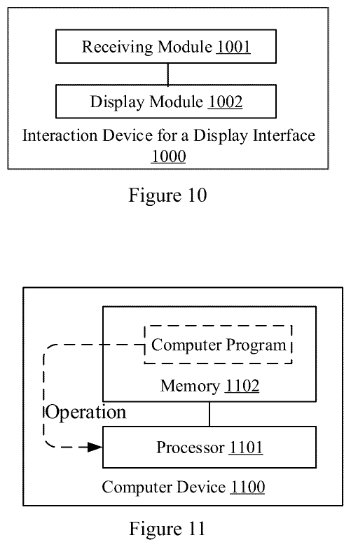

FIG. 10 illustrates a schematic diagram of a composition structure of an interaction device of a display interface, consistent with the disclosed embodiments of the present disclosure. The display interface includes at least one object interaction area and a shared display area. In one embodiment, as shown in FIG. 10, the device 1000 includes a receiving module 1001 and a display module 1002. The receiving module 1001 is configured to receive an operation instruction for an interaction object through the object interaction area. The display module 1002 is configure to display the content to be operated of the interaction object in the shared display area in response to the operation instruction. The object interaction area and the shared interaction area are arranged in different areas of the display interface.

In some embodiments, the display module 1002 is also configured to, when the operation instruction is a first type of operation, display the displayable data of the interaction object in the shared display area as the content to be operated, and when the operation instruction is a second type of operation, display the editable content of the interaction object in the shared display area as the content to be operated.

In some embodiments, the display module 1002 is also configured to: receive a processing operation for the interaction object through the agent interaction area; in response to the processing operation, process the content to be operated based on a processing program corresponding to the processing operation to obtain target content; and display the target content in the agent interaction area and/or the shared display area.

In some embodiments, the display module 1002 is configured to display the generated target content in the agent interaction area; and/or, to receive an insertion operation for the target content through the agent interaction area; in response to the insertion operation on the target content, insert the target content into the content to be operated, and display the updated content to be operated in the shared display area.

In some embodiments, the receiving module 1001 is also configured to, in response to an insertion operation on the target content, determine an insertion position in the content to be operated based on a cursor position of the insertion operation; and insert the target content into the content to be operated based on the insertion position.

In some embodiments, the at least one object interaction area may include an agent interaction area. The receiving module 1001 is also configured to receive, through the shared display area, a first selection operation for the content to be operated; in response to the first selection operation, determine the selected content in the content to be operated; receive, through the agent interaction area, a processing operation for the selected content; in response to the processing operation, process the selected content based on a processing program corresponding to the processing operation to obtain target content; and display the target content in the agent interaction area and/or the shared display area.

In some embodiments, the at least one object interaction area may include an agent interaction area. The receiving module 1001 is also configured to receive an operation instruction through the object interaction area. The operation instruction includes object information of the interaction object. In the display content of the at least one object interaction area, the interaction object may be determined based on the object information.

In some embodiments, the display module 1002 is also configured to generate the content displayed in the object interaction area through a first application program, and to generate the content displayed in the shared interaction area through a second application corresponding to the content to be operated. The first application may be different from the second application.

In some embodiments, the display module 1002 is also configured to, when the shared display area is in an initialization state, determine the display content based on the target interaction area in the at least one object interaction area. The shared display area is also configured to, in response to the operation instruction, update the display content based on the content to be operated for the interaction object.

The interaction device provided by the present disclosure may have similar beneficial effects as the interaction method provided by the present disclosure. In some embodiments, the functions or modules included in the device provided by the present disclosure may be used to execute the method provided by the present disclosure. For technical details of the device provided by the present disclosure, reference may be made to the description of the method provided by the present disclosure.

In one embodiment, when the method is implemented in the form of a software function module and sold or used as an independent product, the method may also be stored in a computer-readable storage medium. Based on this understanding, the technical solution of the present disclosure, or in other words, the part that contributes to the relevant technology, may be embodied in the form of a software product. The software product may be stored in a storage medium, and may include a plurality of instructions for enabling an electronic device (which may be a mobile phone, tablet computer, laptop computer, desktop computer, and the like) to execute each or part of the method described in the present disclosure. The storage medium may include a U disk, a mobile storage device, a read-only memory (ROM), a magnetic disk, an optical disk, and other media that may be used to store program codes. The present disclosure is not limited to any specific hardware, software or firmware, or any combination of hardware, software and firmware.

The present disclosure also provides an electronic device, including a memory and a processor. The memory may be stored with a computer program that may be executed by the processor. When the processor executes the program, part of or each of the operations in the method provided by the present disclosure may be implemented.

The present disclosure also provides a computer-readable storage medium. The computer-readable storage medium is stored with a computer program. When the computer program is executed by a processor, part of or each of the operations in the method provided by the present disclosure may be implemented. The computer-readable storage medium may be transitory or non-transitory.

The present disclosure also provides a computer program, including a computer-readable code. When the computer-readable code runs in an electronic device, a processor in the electronic device may execute part of or each of the operations for implementing the method provided by the present disclosure.

The present disclosure also provides a computer program product. The computer program product may include a non-transitory computer-readable storage medium stored with a computer program. When the computer program is read and executed by a computer, part of or each of the operations in the method provided by the present disclosure may be implemented. The computer program product may be implemented in hardware, software, or a combination thereof. In some embodiments, the computer program product may be specifically embodied as a computer storage medium. In some other embodiments, the computer program product may be specifically embodied as a software product, such as a software development kit (SDK) and the like.

The device, storage medium, computer program, and computer program product provided by the present disclosure may have similar beneficial effects as the method provided by the present disclosure. For technical details of the device, storage medium, computer program, and computer program product provided by the present disclosure, reference may be made to the description of the method provided by the present disclosure.

FIG. 11 illustrates a schematic diagram of a hardware entity of an electronic device consistent with the disclosed embodiments of the present disclosure. As shown in FIG. 11, the hardware entity of the electronic device 1100 includes processor(s) 1101 and a memory 1102. The memory 1102 is stored with a computer program that may be executed by the processor 1101. When the processor 1101 executes the program, the operations in the method provided by the present disclosure may be implemented.

The memory 1102 may be stored with a computer program that may be executed by the processor. The memory 1102 is configured to store instructions and applications executable by the processor 1101, and may also cache data processed or to be processed by the processor 1101 and various modules in the electronic device 1100 (for example, image data, audio data, voice communication data, and video communication data). The memory may be implemented through a flash memory (FLASH) or a random-access memory (RAM).

When the processor 1101 executes the program, the operations of the method provided by the present disclosure may be implemented. In general, the processor 1101 may control the overall operation of the electronic device 1100.

The present disclosure also provides a computer storage medium. The computer storage medium may be stored with one or more programs. The one or more programs may be executed by one or more processors to implement the operations of the method provided by the present disclosure.

The storage medium and the device provided by the present disclosure may have similar beneficial effects as the method provided by the present disclosure. For technical details of the storage medium and the device provided by the present disclosure, reference may be made to the descriptions of the method provided by the present disclosure.

The processor may include at least one of an application specific integrated circuit (ASIC), a digital signal processor (DSP), a digital signal processing device (DSPD), a programmable logic device (PLD), a field programmable gate array (FPGA), a central processing unit (CPU), a controller, a microcontroller, and a microprocessor. It is understandable that the electronic device that performs the processor functions may also include other devices, which are not specifically limited by the present disclosure.

The computer storage medium/memory provided by the present disclosure may include a read-only memory (ROM), a programmable read-only memory (PROM), an erasable programmable read-only memory (EPROM), an electrically erasable programmable read-only memory (EEPROM), a magnetic random-access memory (FRAM), a flash memory, a magnetic surface memory, an optical disk, a compact disc read-only memory (CD-ROM), or the like. The computer storage medium/memory may also be a terminal including one or a combination of the above memories, such as a mobile phone, a computer, a tablet device, a personal digital assistant, and the like.

It should be noted that, the devices and methods provided by the present disclosure may be implemented in other approaches. The embodiments in the present disclosure are merely illustrative. For example, unit division is merely logical function division. There may be other division methods in actual implementation. For example, a part of units or components may be combined, or may be integrated into another system, and a part of features may be ignored, or not performed. In addition, couplings between components may be direct couplings, or may be achieved through indirect couplings or communication connections through interfaces, devices, or units. The couplings may be electrical, mechanical or other forms.

The units described as separate components may or may not be physically separate. Components shown as units may or may not be physical units. The components may be disposed in one place or distributed over a plurality of network units. Part of or each of the units may be selected according to actual needs to achieve the technical solutions of the present disclosure.

In addition, functional units in the embodiments of the present disclosure may be integrated into one processing unit, or each unit may be separately used as a unit, or two or more units may be integrated into a unit. The unit formed by integration may be implemented in the form of hardware, or in the form of hardware combined with software functional units.

Each of or part of the operations of the method embodiments may be completed by hardware related to instructions of a program. The program may be stored in a computer-readable storage medium. When the program is executed, the operations of the method embodiments may be performed. The storage medium may include mobile storage devices, read-only memories (ROM), magnetic disks or optical disks, and other media that may store program codes.

When the unit formed by integration is implemented in the form of a software function module and sold or used as an independent product, the unit formed by integration may also be stored in a computer-readable storage medium. Based on this understanding, the technical solution of the present disclosure, or in other words, the part that contributes to the relevant technology, may be embodied in the form of a software product. The software product may be stored in a storage medium, and may include a plurality of instructions for enabling an electronic device (which may be a mobile phone, tablet computer, laptop computer, desktop computer, and the like.) to execute each or part of the methods described in the present disclosure. The storage medium may include mobile storage devices, ROM, magnetic disks, optical disks, and other media that may store program codes.

As disclosed, the technical solutions of the present disclosure have the following advantages.

In the present disclosure, the display interface includes at least one object interaction area and a shared display area. The at least one object interaction area may use artificial-intelligence natural language processing and machine learning capabilities to directly complete document polishing, icon generation and other operations within an application. As such, the document operations may not require exiting the current application, and the document operations may thus become simpler and more efficient. Accordingly, the convenience and smoothness of the interaction experience may be improved.

The embodiments disclosed in the present disclosure are exemplary only and not limiting the scope of the present disclosure. Various combinations, alternations, modifications, or equivalents to the technical solutions of the disclosed embodiments may be obvious to those skilled in the art and may be included in the present disclosure. Without departing from the spirit of the present disclosure, the technical solutions of the present disclosure may be implemented by other embodiments, and such other embodiments are intended to be encompassed within the scope of the present disclosure.

What is claimed is:

1. An interaction method for a display interface that includes at least one object interaction area and a shared display area, the method comprising:
receiving an operation instruction for an interaction object through an object interaction area of the at least one object interaction area; and
in response to the operation instruction, displaying content to be operated of the interaction object in the shared display area,
wherein the object interaction area and the shared display area are in different areas of the display interface.

2. The method according to claim 1, wherein, in response to the operation instruction, displaying the content to be operated of the interaction object in the shared display area includes:
when the operation instruction is a first type of operation, displaying displayable data of the interaction object in the shared display area as the content to be operated; and
when the operation instruction is a second type of operation, displaying editable content of the interaction object in the shared display area as the content to be operated.

3. The method according to claim 2, wherein:
the at least one object interaction area includes an agent interaction area; and
after displaying the editable content of the interaction object in the shared display area as the content to be operated, the method further includes:
receiving a processing operation for the interaction object through the agent interaction area;
in response to the processing operation, processing the content to be operated based on a processing program corresponding to the processing operation to obtain target content; and
displaying the target content in the agent interaction area and/or the shared display area.

4. The method according to claim 3, wherein displaying the target content in the agent interaction area and/or the shared display area includes:
displaying the target content in the agent interaction area; and/or
receiving an insertion operation for the target content through the agent interaction area; in response to the insertion operation for the target content, inserting the target content into the content to be operated, resulting in an updated content to be operated; and displaying the updated content to be operated in the shared display area.

5. The method according to claim 4, wherein, in response to the insertion operation for the target content, inserting the target content into the content to be operated, include:
in response to the insertion operation for the target content, determining an insert position in the content to be operated based on a cursor position of the insertion operation; and
based on the insertion position, inserting the target content into the content to be operated.

6. The method according to claim 2, wherein:
the at least one object interaction area includes an agent interaction area; and
after displaying the editable content of the interaction object in the shared display area as the content to be operated, the method further includes:
receiving, through the shared display area, a first selection operation for the content to be operated;
in response to the first selection operation, determining selected content in the content to be operated;
receiving a processing operation for the selected content through the agent interaction area;
in response to the processing operation, processing the selected content based on a processing program corresponding to the processing operation to obtain target content; and
displaying the target content in the agent interaction area and/or the shared display area.

7. The method according to claim 1, wherein:
the at least one object interaction area includes an agent interaction area; and
receiving the operation instruction for the interaction object through the object interaction area of the at least one object interaction area includes:
receiving the operation instruction through the object interaction area, wherein the operation instruction includes object information of the interaction object; and
in display content of the at least one object interaction area, determining the interaction object based on the object information.

8. The method according to claim 1, wherein:
content displayed in the object interaction area is generated by a first application;
content displayed in the shared interaction area is generated by a second application corresponding to the content to be operated; and
the first application is different from the second application.

9. The method according to claim 1, wherein:
the shared display area is configured to, in an initialization state, determine display content based on a target interaction area of the at least one object interaction area; and
the shared display area is further configured to, in response to the operation instruction, update the display content based on the content to be operated of the interaction object.

10. An electronic device comprising:
one or more processors and a memory containing a computer program that, when being executed, causes the one or more processors to perform an interaction method for a display interface that includes at least one object interaction area and a shared display area, wherein the one or more processors are configured to perform:
receiving an operation instruction for an interaction object through an object interaction area of the at least one object interaction area; and
in response to the operation instruction, displaying content to be operated of the interaction object in the shared display area,
wherein the object interaction area and the shared display area are in different areas of the display interface.

11. The device according to claim 10, wherein the one or more processors are further configured to perform:
when the operation instruction is a first type of operation, displaying displayable data of the interaction object in the shared display area as the content to be operated; and
when the operation instruction is a second type of operation, displaying editable content of the interaction object in the shared display area as the content to be operated.

12. The device according to claim 11, wherein:
the at least one object interaction area includes an agent interaction area; and
after displaying the editable content of the interaction object in the shared display area as the content to be operated, the one or more processors are further configured to perform:
receiving a processing operation for the interaction object through the agent interaction area;
in response to the processing operation, processing the content to be operated based on a processing program corresponding to the processing operation to obtain target content; and
displaying the target content in the agent interaction area and/or the shared display area.

13. The device according to claim 12, wherein the one or more processors are further configured to perform:
displaying the target content in the agent interaction area; and/or
receiving an insertion operation for the target content through the agent interaction area; in response to the insertion operation for the target content, inserting the target content into the content to be operated, resulting in an updated content to be operated; and displaying the updated content to be operated in the shared display area.

14. The device according to claim 13, wherein the one or more processors are further configured to perform:
in response to the insertion operation for the target content, determining an insert position in the content to be operated based on a cursor position of the insertion operation; and
based on the insertion position, inserting the target content into the content to be operated.

15. The device according to claim 11, wherein:
the at least one object interaction area includes an agent interaction area; and
after displaying the editable content of the interaction object in the shared display area as the content to be operated, the one or more processors are further configured to perform:
receiving, through the shared display area, a first selection operation for the content to be operated;
in response to the first selection operation, determining selected content in the content to be operated;
receiving a processing operation for the selected content through the agent interaction area;
in response to the processing operation, processing the selected content based on a processing program corresponding to the processing operation to obtain target content; and
displaying the target content in the agent interaction area and/or the shared display area.

16. The device according to claim 10, wherein:
the at least one object interaction area includes an agent interaction area; and
the one or more processors are further configured to perform:
receiving the operation instruction through the object interaction area, wherein the operation instruction includes object information of the interaction object; and
in display content of the at least one object interaction area, determining the interaction object based on the object information.

17. The device according to claim 10, wherein:
content displayed in the object interaction area is generated by a first application;
content displayed in the shared interaction area is generated by a second application corresponding to the content to be operated; and
the first application is different from the second application.

18. The device according to claim 10, wherein:
the shared display area is configured to, in an initialization state, determine display content based on a target interaction area of the at least one object interaction area; and
the shared display area is further configured to, in response to the operation instruction, update the display content based on the content to be operated of the interaction object.

19. A non-transitory computer readable storage medium containing a computer program that, when being executed, causes at least one processor to perform an interaction method for a display interface that includes at least one object interaction area and a shared display area, wherein the at least one processor is configured to perform:
receiving an operation instruction for an interaction object through an object interaction area of the at least one object interaction area; and
in response to the operation instruction, displaying content to be operated of the interaction object in the shared display area,
wherein the object interaction area and the shared display area are in different areas of the display interface.

20. The storage medium according to claim 10, wherein the at least one processor is further configured to perform:
when the operation instruction is a first type of operation, displaying displayable data of the interaction object in the shared display area as the content to be operated; and
when the operation instruction is a second type of operation, displaying editable content of the interaction object in the shared display area as the content to be operated.
